(19) United States
(12) Patent Application Publication
(10) Pub. No.: US 2010/0089829 A1
(43) Pub. Date: Apr. 15, 2010

(54) MEMBRANE CLEANING METHOD AND APPARATUS

(75) Inventors: Chien-Hung Chen, Taoyuan County (TW); Chen-Hua Chu, Taipei County (TW); Wang-Kuan Chang, Hsinchu City (TW); Shan-Shan Chou, Hsinchu County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Industrial Technology Research Institute, Hsin-Chu (TW)

(21) Appl. No.: 12/505,480

(22) Filed: Jul. 18, 2009

(30) Foreign Application Priority Data
Oct. 14, 2008 (TW) 097139307

(51) Int. Cl. B01D 65/02

(52) U.S. Cl. 210/636; 210/243

(57) ABSTRACT

A membrane cleaning apparatus comprising two electrode plates and a filtration unit is provided, wherein the filtration unit is disposed between the electrode plates. The filtration unit comprises a supporting plate and a membrane, and the membrane is disposed on the support plate. This invention can effectively clean the fouling on the membrane by applying an electric field in the membrane region and performing a back flushing process on the membrane. Moreover, a membrane cleaning method is also provided.

### FIELD OF THE INVENTION

The present invention generally relates to a membrane cleaning apparatus and a method thereof and, more particularly, to a membrane cleaning apparatus and a method thereof using an applied electric field.

### BACKGROUND OF THE INVENTION

The membrane has been widely used in water purification and has thus become a core technique. The global market of membrane application is expected to exceed 43 billion in 2010. Membrane fouling is still the bottlenecks that need to overcome. In other words, membrane fouling has limited the market growth and application of membrane.

Membrane fouling reduces the flux and increases the trans-membrane pressure (TMP). Accordingly, the membrane has to be cleaned to restore its functionality. However, as the number of cleaning increases, the membrane flux decreases or it has to be cleaned more frequently. This is attributed to the increasing irreversible filtration resistance. In other words, membrane cleaning is not effective so that the lifetime of membrane is shortened and the flux is reduced.

FIG. 1 shows the variation of membrane flux. It is observed that the membrane flux decreases with time and membrane cleaning frequency. The membrane has to be cleaned to restore the membrane flux when the membrane flux is lowered to a specific value (the points in FIG. 1).

There are three major factors for membrane fouling, such as pore narrowing, pore plugging and cake formation. Pore plugging is the hardest to remove and is the key factor that the maximum membrane flux decreases.

Presently, the membrane is cleaned using chemicals. Practically, back flushing using water is the most common method but the performance is poor because it is difficult to remove pore plugging. On the other hand, cleaning using chemicals results in better performance but it produces secondarily wastes. Moreover, cleaning using chemicals is environmental unfriendly because the chemicals may comprise alkali, acid, detergent and oxidant such as hypochlorous acid to produce toxic or polluted wastes.

### SUMMARY OF THE INVENTION

Accordingly, the present invention provides a membrane cleaning apparatus and a membrane cleaning method capable of restoring the initial flux after the membrane cleaning. It can effectively eliminate membrane scale, bio-fouling and pore plugging.

The present invention provides a membrane cleaning apparatus capable of cleaning plate-and-frame membranes, the membrane cleaning apparatus comprising two electrode plates and a filtration unit, wherein the filtration unit is disposed between the electrode plates. The filtration unit comprises a supporting plate and a membrane disposed on the supporting plate.

The present invention further provides a membrane cleaning apparatus capable of cleaning hollow-fiber membranes, the membrane cleaning apparatus comprising two electrode plates and a filtration unit, wherein the filtration unit is disposed between the electrode plates. The filtration unit comprises an electrode line and a membrane wrapped around the electrode line.

The present invention further provides a membrane cleaning apparatus capable of cleaning spiral wound membranes, the membrane cleaning apparatus comprising a first electrode plate, a second electrode plate, a third electrode plate, a first membrane and a second membrane, wherein the first membrane is laminated between the first electrode plate and the second electrode plate, while the second membrane is laminated between the second electrode plate and the third electrode plate, wherein the first electrode plate, the first membrane, the second electrode plate, the second membrane and the third electrode plate are wrapped as a cylinder.

The present invention further provides a membrane cleaning method, comprising steps of: providing a membrane and applying an electric field through the membrane; and performing a back flushing process on the membrane.

Accordingly, in the membrane cleaning apparatus and the membrane cleaning method of the present invention, an electric field is applied around the membrane to temporarily change the state of the membrane and enlarge the pores in the membrane to further improve the performance of back flushing and overcome the problems due to pore plugging, bio-fouling and membrane scalling.

### BRIEF DESCRIPTION OF THE DRAWINGS

The objects and spirits of various embodiments of the present invention will be readily understood by the accompanying drawings and detailed descriptions, wherein:

FIG. 1 shows the flux of a membrane with respect to time;

FIG. 2A and FIG. 2B are cross-sectional views of a membrane cleaning apparatus according to one embodiment of the present invention;

FIG. 3A to FIG. 3C are cross-sectional views of a membrane cleaning apparatus according to another embodiment of the present invention;

FIG. 4 is a cross-sectional view of a membrane cleaning apparatus according to another embodiment of the present invention;

FIG. 5A and FIG. 5B are 3-D views of a membrane cleaning apparatus according to another embodiment of the present invention;

FIG. 6A is a cross-sectional view of a membrane cleaning apparatus according to another embodiment of the present invention;

FIG. 6B is an exploded view of a membrane cleaning apparatus in FIG. 6A;

FIG. 7 is a flowchart of a membrane cleaning method according to one embodiment of the present invention;

FIG. 8 is an experimental result showing the membrane pressure and membrane flux with respect to time when an electric field is applied; and

FIG. 9 is an experimental result showing the relative luminosity with respect to time when an electric field is applied.

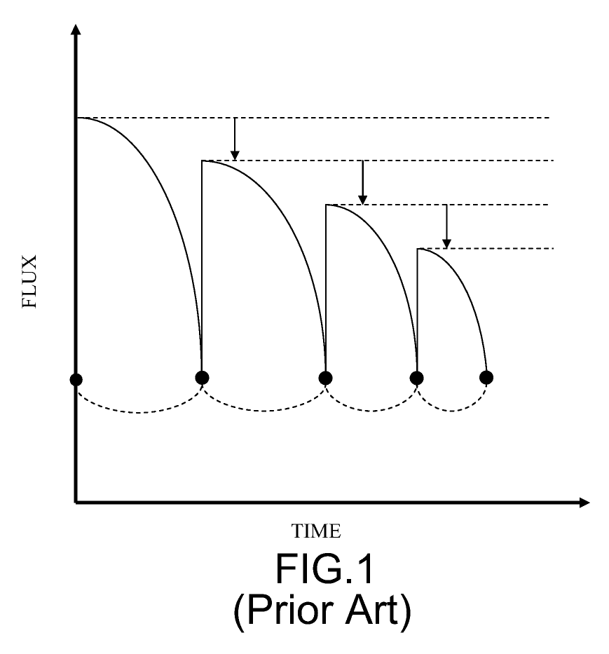

### DETAILED DESCRIPTION OF THE PREFERRED EMBODIMENT

The present invention can be exemplified by but not limited to various embodiments as described hereinafter.

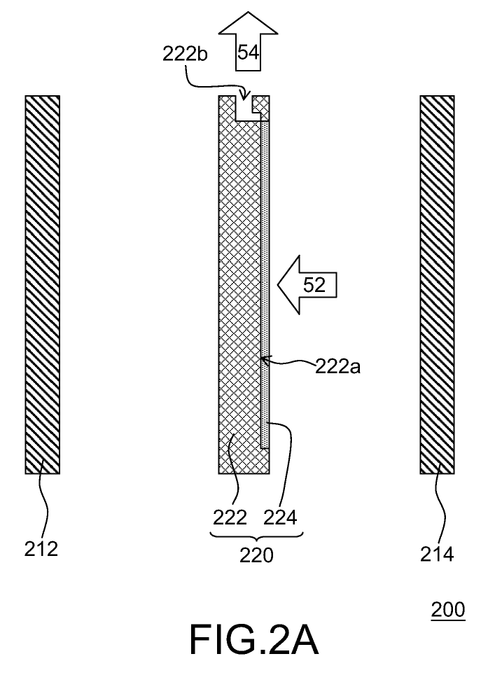

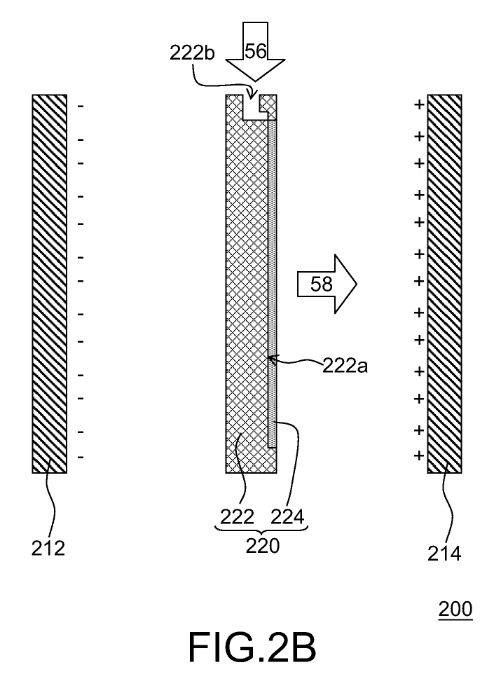

FIG. 2A and FIG. 2B are cross-sectional views of a membrane cleaning apparatus according to one embodiment of the present invention. Referring to FIG. 2A, the membrane cleaning apparatus 200 of the present invention comprises two electrode plates 212, 214 and a filtration unit 220. The filtration unit 220 is disposed between the electrode plates 212, 214. Moreover, the filtration unit 220 comprises a supporting plate 222 and a membrane 224, which is disposed on the supporting plate 222 to filter raw water and produce purified water.

In the present embodiment, the membrane 224 is a reverese osmosis (RO) membrane. However, the present invention is not limited to the type of the membrane 224. For example, the membrane 224 may also be a nanofiltration (NF) membrane, an ultrafiltration (UF) membrane, a microfiltration (MF) membrane or any other suitable filtration membrane.

Accordingly, the membrane 224 is laid against a water-guiding surface 222a with trenches thereon of the supporting plate 222. During water filtration by the membrane 224, the raw water 52 (as denoted by the arrow in FIG. 2A) passes through the membrane 224 and enters the water-guiding surface 222a with trenches thereon. The water-guiding surface 222a on the supporting plate 222 is provided with a water-guiding mechanism (not shown) capable of collecting purified water 54 (as denoted by the arrow in FIG. 2A) that has been filtered by the membrane 224 and discharging the purified water 54 from the water collector 222b disposed on top of the supporting plate 222.

Referring to FIG. 2B, after the membrane 224 has filtered raw water for a certain period of time, a membrane cleaning process is required. In the present embodiment, electricity is applied across the electrode plates 212, 214 so that the electrode plate 212 exhibits a first electric polarity, while the electrode plate 214 exhibits a second electric polarity so as to generate an electric field through the membrane 224. In the present embodiment, the first electric polarity is, for example, negative, while the second electric polarity is, for example, positive. However, the present invention is not limited to the polarities being positive, negative or alternate.

Then, the purified water 56 is input from the water collector 222b to perform a back flushing process to remove the fouling on the membrane 224. During the back flushing process, the water passing through the membrane 224 becomes foul water. In other words, the present invention changes the electric field through the membrane 224 to improve the performance of back flushing. In the present invention, the electrified back flushing process by purified water provides better performance than the conventional back flushing with purified water, chemical cleaning or ultrasonic resonance and is free of chemical residues. The electrified back flushing process will be described in detail herein.

(1) The electrified process is capable of adjusting the electrostatic repulsion or surface potential on the surface of the membrane 224 according to the water quality and the fouling so that the absorbed particles or the fouling can depart from the surface of the membrane 224. Therefore, the back flushing process using purified water can improve the cleaning of the membrane 224. Moreover, the present invention may also use crossflow bubbles to scour the surface of the membrane 224 to further improve the cleaning.

(2) Extracellular polymeric substances (EPS) are the main reason that causes bio-fouling on the membrane 224. The electrified process is capable of breaking the linking between the extracellular polymeric substances and the membrane 224 so that the fouling may depart from the surface of the membrane 224 under the electric field to achieve membrane cleaning.

(3) The microorganism and bacteria may be deactivated under an applied electric field. Moreover, sodium chloride can be added to purified water to produce hypochlorous acid and chlorine by electrolysis to improve membrane cleaning. Certainly, even though the present invention can be used without any chemical to be added to purified water for qualified cleaning, these chemical can be added to purified water to further improve cleaning.

(4) The electrified process can improve membrane flux due to electroosmosis. In other words, the flux can be enhanced by cleaning, and cleaning can be improved by scour.

(5) The pores in the membrane 224 can be deformed by the electric field to overcome pore plugging, and thus the particles stuck in the pores can be washed out.

(6) The back flushing process using purified water does not requires chemicals and is environment-friendly with reliable cleaning performance.

In the present embodiment, the supporting plate 222 may comprise acrylic or plastic. The electrode plates 212, 214 may comprise a conductive material such as graphite, alloy, stainless steel or diamond. However, the present invention is not limited to the material used in the supporting plate 222 and the electrode plates 212, 214.

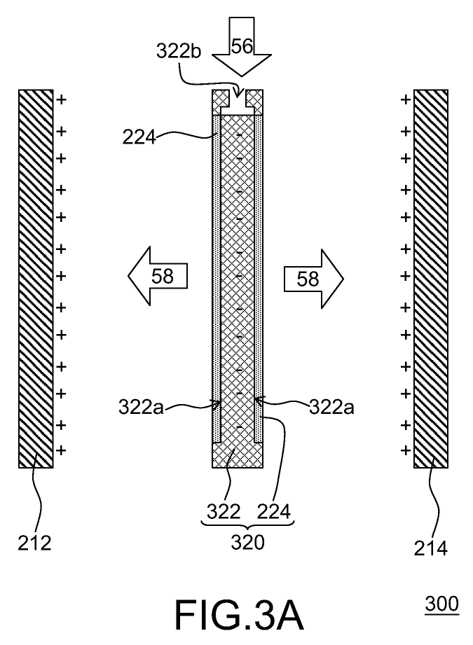

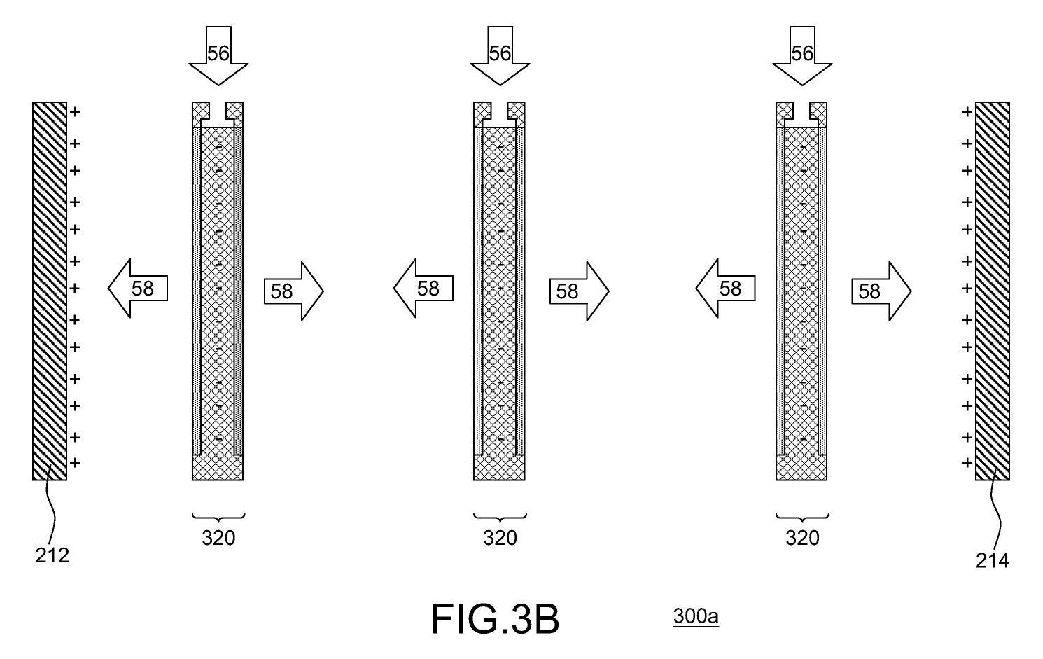

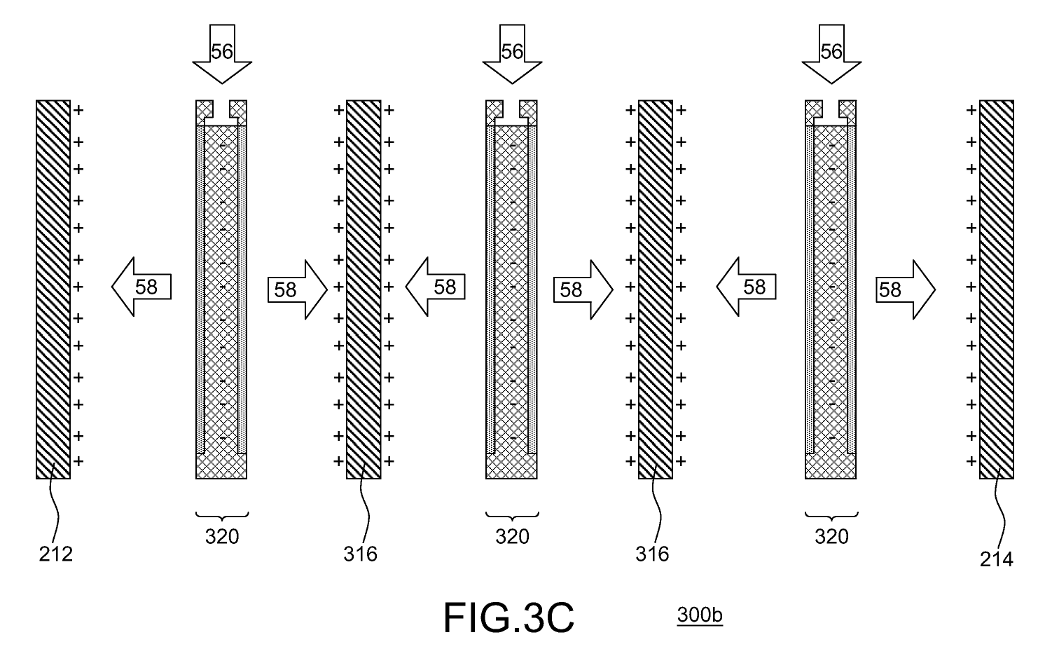

FIG. 3A is a cross-sectional view of a membrane cleaning apparatus according to another embodiment of the present invention. Referring to FIG. 3A, the membrane cleaning apparatus 300 of the present embodiment and is similar to the aforesaid membrane cleaning apparatus 200 (in FIG. 2A) except that the supporting plate 322 of the filtration unit 320 comprises a conductive material, and two water-guiding surfaces 322a with trenches thereon of the supporting plate 322 can be provided with a membrane 224, respectively. During cleaning according to the present embodiment, the electrode plates 212, 214 and the supporting plate 322 receive electricity so that the supporting plate 322 exhibits a first electric polarity (being negative, for example) and the electrode plates 212, 214 exhibit a second electric polarity (being positive, for example) so as to generate an electric field through the membrane 224.

Then, purified water 56 is guided from the water collector 322b to perform the back flushing process, so as to wash away the fouling on the membrane 224. The water passing through the membrane 224 becomes foul water 58, as is readily understood by one with ordinary skill in art and description thereof is not presented herein.

Moreover, the previous embodiment in FIG. 3A is a prototype, which can be developed into various modifications, for example, in FIG. 3B and FIG. 3C. In FIG. 3B, the membrane cleaning apparatus 300a provides a filtration unit 320 disposed between two electrode plates 212, 214. In FIG. 3C, the membrane cleaning apparatus 300b further provides an electrode plate 316 disposed between two filtration units 320, wherein the electrode plate 316 receives electricity to exhibit a second electric polarity (being positive, for example).

One with ordinary skill in the art can make various modifications based on the previously presented descriptions, but any of these modifications is still within the scope of the present invention.

In the present embodiment, the membrane cleaning apparatus can be used on different occasions such as:

(1) Regularly: The membrane is cleaned automatically on regular occasions.

(2) Trans-membrane pressure (TMP) threshold: when the TMP value exceeds a predetermined threshold, the membrane is cleaned automatically.

(3) Flux threshold: when the flux is lowered to a predetermined threshold, the membrane is cleaned automatically.

(4) Water quality threshold: when the water quality cannot meet the requirements as designed, the membrane is cleaned automatically.

(5) Manually.

Certainly, the present invention is not limited to the aforesaid occasions. The membrane cleaning apparatus may further comprise a trans-membrane pressure (TMP) monitor, a flux monitor or an automatic recorder to start membrane cleaning.

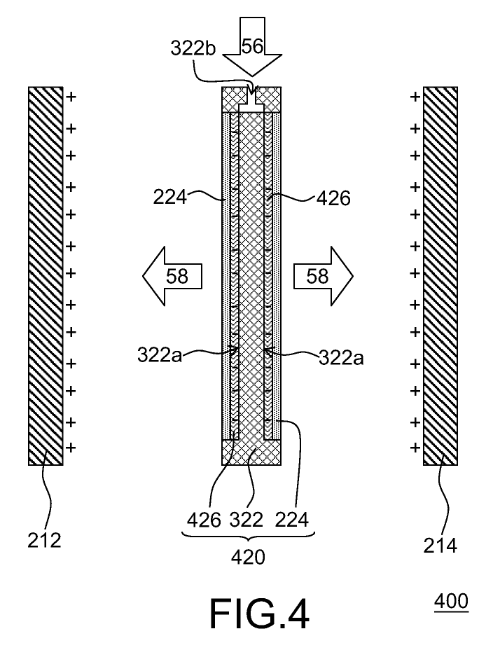

FIG. 4 is a cross-sectional view of a membrane cleaning apparatus according to another embodiment of the present invention. Referring to FIG. 4, the membrane cleaning apparatus 400 of the present embodiment and is similar to the aforesaid membrane cleaning apparatus 300 (in FIG. 3A) except that the filtration unit 420 further comprises a spacer 426 for better filtration. The spacer 426 is disposed between the water-guiding surface 322a with trenches thereon of the supporting plate 322 and the membrane 224. The spacer 426 comprises a conductive material.

During cleaning according to the present embodiment, the electrode plates 212, 214 and the spacer 426 receive electricity so that the spacer 426 exhibits a first electric polarity (being negative, for example) and the electrode plates 212, 214 exhibit a second electric polarity (being positive, for example) so as to generate an electric field through the membrane 224.

Then, purified water 56 is guided from the water collector 322b to perform the back flushing process, so as to wash away the fouling on the membrane 224. The water passing through the membrane 224 becomes foul water 58.

It is noted that the present invention is not limited to the types of the filtration unit, as will be described in the following embodiments.

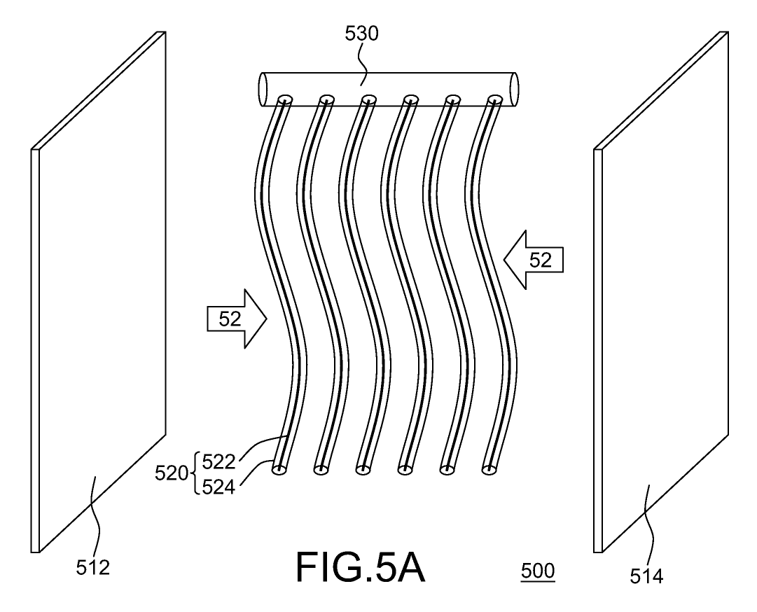

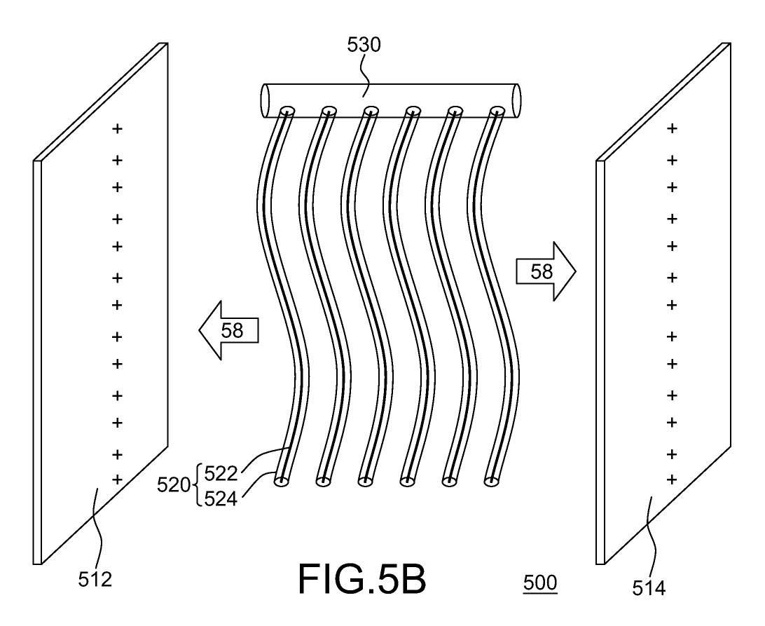

FIG. 5A and FIG. 5B are 3-D views of a membrane cleaning apparatus according to another embodiment of the present invention. Referring to FIG. 5A, the membrane cleaning apparatus 500 of the present embodiment comprises electrode plates 512, 514 and a plurality of filtration units 520. The filtration units 520 are disposed between the electrode plate 512, 514. Each of the filtration units 520 comprises an electrode line 522 and a membrane 524 wrapped around the electrode line 522 so that the filtration unit 520 looks like a tube. Moreover, the present invention is not limited to the number of the filtration unit 520.

Moreover, the membrane cleaning apparatus 500 may further comprise a hose 530 connected to these filtration units 520. During filtration of the membrane 524, raw water 52 (as denoted by the arrow in the figure) passes through the membrane 224 to be filtered and then enters the center of the filtration unit 520. Finally, purified water from the membrane 524 (not shown) is guided along the hose to be discharged.

Referring to FIG. 5B, as the membrane 524 has filtered raw water for a certain period of time, membrane cleaning is required. In the present embodiment, the electrodes 5 12, 514 and the electrode line 522 receive electricity so that the electrode line 522 exhibits a first electric polarity (being negative, not shown), while the electrodes 512, 514 exhibit a second electric polarity (being positive) so as to generate an electric field through the membrane 224. Then, purified water (not shown) is guided along the hose 530 to perform the back flushing process to wash away the fouling on the membrane 524. The water passing through the membrane 524 becomes foul water 58.

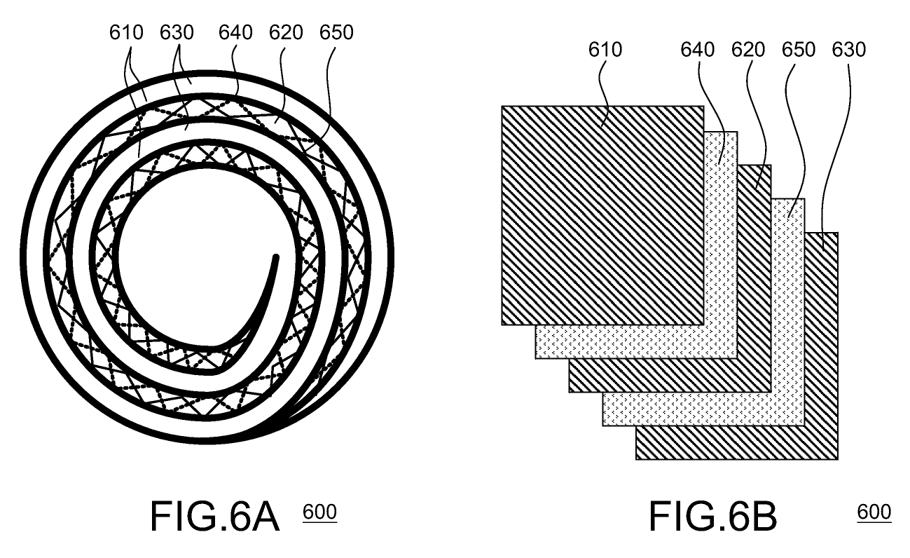

FIG. 6A is a cross-sectional view of a membrane cleaning apparatus according to another embodiment of the present invention; and FIG. 6B is an exploded view of a membrane cleaning apparatus in FIG. 6A. Referring to FIG. 6A and FIG. 6B, the membrane cleaning apparatus 600 of the present embodiment comprises a first electrode plate 610, a second electrode plate 620, a third electrode plate 630, a first membrane 640 and a second membrane 650. The first membrane 630 is laminated between the first electrode plate 610 and the second electrode plate 620, while the second membrane 650 is laminated between the second electrode plate 620 and the third electrode plate 630. The first electrode plate 610, the first membrane 640, the second electrode plate 620, the second membrane 650 and the third electrode plate 630 are wrapped as a cylinder.

Moreover, the first electrode plate 610, the second electrode plate 620, and the third electrode plate 630 are provided with water-guiding mechanism on the surfaces. During filtration by the first membrane 640 and the second membrane 650, raw water (not shown) is guided along the water-guiding mechanism on the second electrode plate 620 into the first membrane 640 and the second membrane 650 for filtration to enter the water-guiding mechanism on the first electrode plate 610 and the third electrode plate 630 and to be discharged.

As the first membrane 640 and the second membrane 650 have filtered raw water for a certain period of time, membrane cleaning is required. In the present embodiment, the first electrode plate 610, the second electrode plate 620 and the third electrode plate 630 receive electricity so that the second electrode plate 620 exhibits a first electric polarity (being positive, not shown), while the first electrode plate 610 and the third electrode plate 630 exhibit a second electric polarity (being negative, not shown) so as to generate an electric field through the first membrane 640 and the second membrane 650. Then, purified water (not shown) is guided by the water-guiding mechanism on the first electrode plate 610 and the third electrode plate 630 to perform the back flushing process to wash away the fouling on the first membrane 640 and the second membrane 650.

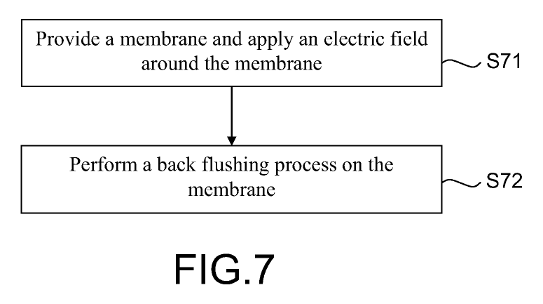

The membrane cleaning method of the present invention has been briefly described with the membrane cleaning apparatus. To make one with ordinary skill in the art better understand the membrane cleaning method, FIG. 7 shows a flowchart of a membrane cleaning method according to one embodiment of the present invention. Referring to FIG. 7, the membrane cleaning method of the present invention comprising two steps. First, as shown in step S71, a membrane is provided and an electric field is applied through the membrane. Then, as shown in step S72, a back flushing process is performed on the membrane.

As stated above, the generation of the electric field through the membrane has been described. For example, the electric field can be generated by two electrodes, by the electrodes and the supporting plat, by the electrodes and the spacer or by the electrodes and the electrode line, which is readily understood by one with ordinary skill in the art and description thereof is not presented.

In the present invention, the membrane cleaning method is capable of making the particles depart from the surface of the membrane easily, breaking the linking between the extracellular polymeric substances and the membrane, and deactivating the microorganism and bacteria. Moreover, the electrified process can improve membrane flux due to electroosmosis without adding chemicals. The pores can be deformed by the electric field to overcome pore plugging, and thus the particles stuck in the pores can be washed out.

Experiment: Change in Pore Aperture

Two microfiltration membranes (MF) are tested in this experiment using kaolin solution to measure the particle diameter on the inlet and the outlet of the membrane. By measuring the diameter of particles passing through the membrane, the change in pore structure can be observed. Experimental result shows that the average diameter of the particles passing through the PE membrane (Kubota) increases from the range of 40-50 nm (under no electric field) to the range of 80-90 nm (under an electric field). However, for a non woven membrane, the average diameter of the particles passing through the PE membrane (Kubota) increases from the range of 20-30 nm (under no electric field) to the range of 180-200 nm (under an electric field). Accordingly, the electric field has strong influence on the pore aperture and the change depends on the membrane material. Pore deformation can overcome the most difficult problem of pore plugging and the particles stuck in the pores may be washed away due to the deformation of the pores.

Experiment: Change in Flux and Membrane Pressure

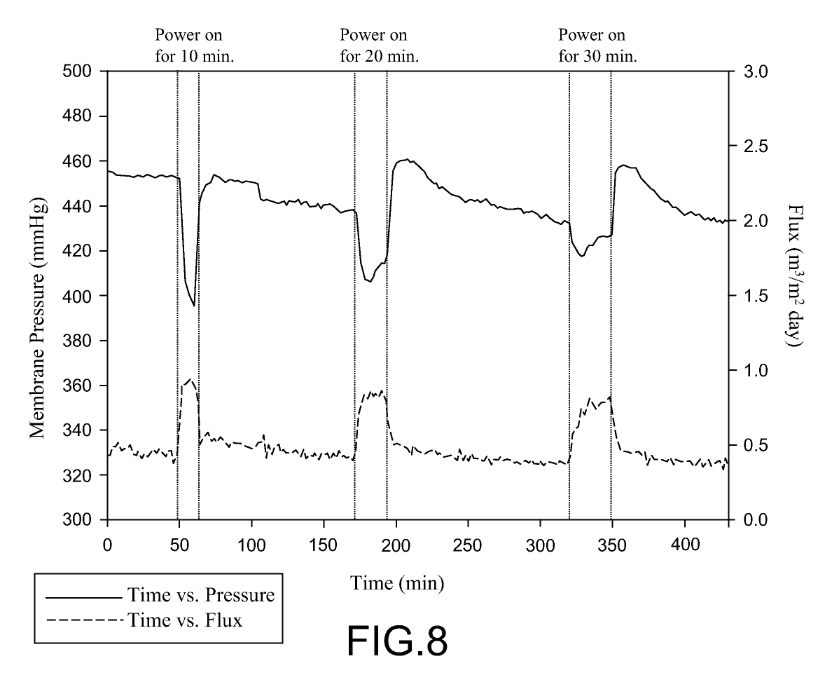

FIG. 8 is an experimental result showing the membrane pressure and membrane flux with respect to time when an electric field is applied. In this experiment, active sludge is used a water with discontinuous operation at a current of reaction tank being 6 mA/cm². Experimental result shows that the electroosmosis effect occurs in the membrane under an electric field so that the flux is increased and the membrane pressure is reduced.

Experiment: Activity Test on Microorganism

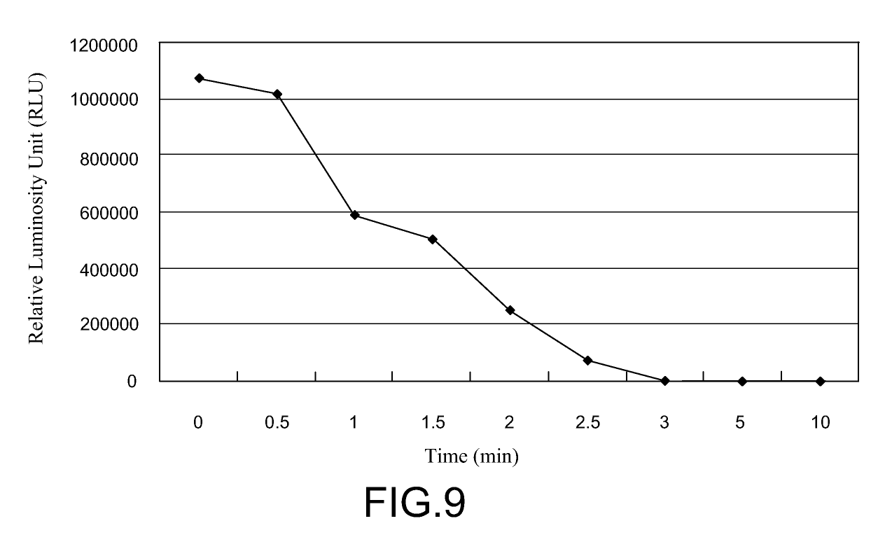

The microorganism activity test is operated under an electric field. An operation voltage of 27.7 V/mL is applied to electrolyze water. The bacterial count and relative luminosity units (RLU) are sampled regularly for analysis. Experimental result shows that the microorganism activity is lowered so that elimination of bio-fouling is achieved. The result as well as the conditions used in the microorganism activity test is shown in FIG. 9.

According the experimental result, RLU is lowered to zero after 3-minute electrolysis. Moreover, the bacterial count is analyzed and the result matches the trend. In the first 5 minutes, the algal filtrate (CFU/ml) is too high to be counted. After 10 minutes of reaction, algal filtrate (CFU/ml) is reduced to zero. Therefore, it is evident that the microorganism and bacteria are deactivated under an electric field so that the bio-fouling on the membrane is reduced, which is helpful for back flushing.

Accordingly, the membrane cleaning apparatus and the membrane cleaning method of the present invention have advantages such as:

1. An electric field is applied through the membrane to improve the performance by back flushing using purified water and effectively remove the fouling such as pore plugging.

2. The electric field is capable of removing microorganism and bacteria to overcome bio-fouling on the membrane.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A membrane cleaning apparatus, comprising:
two electrode plates; and
a filtration unit disposed between the electrode plates, the filtration unit comprising:
a supporting plate; and
a membrane disposed on the supporting plate.

2. The membrane cleaning apparatus as recited in claim 1, wherein the two electrode plates exhibit a first electric polarity and a second electric polarity, respectively.

3. The membrane cleaning apparatus as recited in claim 1, wherein the supporting plate comprises a conductive material.

4. The membrane cleaning apparatus as recited in claim 3, wherein the supporting plate exhibits a first electric polarity, while the electrode plates exhibit a second electric polarity.

5. The membrane cleaning apparatus as recited in claim 4, wherein the first electric polarity is negative, while the second electric polarity is positive.

6. The membrane cleaning apparatus as recited in claim 1, wherein the filtration unit further comprises a spacer comprising a conductive material disposed between the supporting plate and the membrane.

7. The membrane cleaning apparatus as recited in claim 6, wherein the spacer exhibits a first electric polarity, while the electrode plates exhibit a second electric polarity.

8. The membrane cleaning apparatus as recited in claim 7, wherein the first electric polarity is negative, while the second electric polarity is positive.

9. A membrane cleaning apparatus, comprising:
two electrode plates; and
a filtration unit disposed between the electrode plates, the filtration unit comprising:
an electrode line; and
a membrane wrapped around the electrode line.

10. The membrane cleaning apparatus as recited in claim 9, further comprising a hose connected to the filtration unit.

11. The membrane cleaning apparatus as recited in claim 9, wherein the electrode line exhibits a first electric polarity, while the electrodes exhibit a second electric polarity.

12. The membrane cleaning apparatus as recited in claim 11, wherein the first electric polarity is positive, while the second electric polarity is negative.

13. A membrane cleaning apparatus, comprising:
a first electrode plate;
a second electrode plate;
a third electrode plate;
a first membrane laminated between the first electrode plate and the second electrode plate; and
a second membrane laminated between the second electrode plate and the third electrode plate;
wherein the first electrode plate, the first membrane, the second electrode plate, the second membrane and the third electrode plate are wrapped as a cylinder.

14. The membrane cleaning apparatus as recited in claim 13, wherein the second electrode plate exhibits a first electric polarity, while the first electrode plate and the third electrode plate exhibit a second electric polarity.

15. The membrane cleaning apparatus as recited in claim 14, wherein the first electric polarity is positive, while the second electric polarity is negative.

16. A membrane cleaning method, comprising steps of:
providing a membrane and applying an electric field through the membrane; and
performing a back flushing process on the membrane.

17. The membrane cleaning method as recited in claim 16, wherein the step of applying an electric field through the membrane comprises steps of:
providing two electrode plates where between the membrane is disposed; and
applying an electric field across the electrode plates so that the electrode plates exhibit a first electric polarity and a second electric polarity, respectively.

18. The membrane cleaning method as recited in claim 16, wherein the step of applying an electric field through the membrane comprises steps of:
providing a supporting plate comprising a metal material whereon the membrane is disposed;
providing two electrode plates where between the supporting plate is disposed; and
applying an electric field across the electrode plates and through the supporting plate so that the supporting plate exhibits a first electric polarity, while the electrode plates exhibit a second electric polarity.

19. The membrane cleaning method as recited in claim 18, wherein the first electric polarity is negative, while the second electric polarity is positive.

20. The membrane cleaning method as recited in claim 16, wherein the step of applying an electric field through the membrane comprises steps of:
providing a supporting plate whereon the membrane is disposed;
providing a spacer comprising a conductive material disposed between the membrane and the supporting plate;
providing two electrode plates where between the supporting plate is disposed; and
applying an electric field across the electrode plates and through the spacer so that the spacer exhibits a first electric polarity, while the electrode plates exhibit a second electric polarity.

21. The membrane cleaning method as recited in claim 20, wherein the first electric polarity is negative, while the second electric polarity is positive.

22. The membrane cleaning method as recited in claim 16, wherein the step of applying an electric field through the membrane comprises steps of:
providing an electrode line where around the membrane is wrapped;
providing two electrode plates where between the electrode line is disposed; and
applying an electric field across the electrode plates and through the supporting plate so that the electrode line exhibits a first electric polarity, while the electrode plates exhibit a second electric polarity.

23. The membrane cleaning method as recited in claim 22, wherein the first electric polarity is negative, while the second electric polarity is positive.
